(19) United States
(12) Patent Application Publication
(10) Pub. No.: US 2010/0095804 A1
(43) Pub. Date: Apr. 22, 2010

(54) DEVICE HOUSING WITH AT LEAST TWO UPRISING FEET

(76) Inventor: Norbert Gilbert, Niederkirchen (DE)

Correspondence Address: QUARLES & BRADY LLP, 411 E. WISCONSIN AVENUE, SUITE 2040, MILWAUKEE, WI, 53202-4497, US

(21) Appl. No.: 12/579,836

(22) Filed: Oct. 15, 2009

(30) Foreign Application Priority Data
Oct. 16, 2008 (DE) 10 2008 051 874.3

(51) Int. Cl. F16H 57/04

(52) U.S. Cl. 74/606 A

(57) ABSTRACT

Device comprising a housing having one side on which at least two support feet with support surfaces are provided, wherein the support feet project beyond the surface forming the side, thereby creating a free space between the surface forming the side and the plane in which the support surface coming closest to the surface is located, wherein the device has a drivable shaft that extends through an opening in the housing from outside into the housing, wherein a fan wheel is disposed on that section of the shaft located outside the housing, the fan wheel generating an air flow when the shaft rotates that passes over the surface forming the side, and a cover is attached to the support feet so as to create a free space that is delimited by the cover and the surface forming the side and through which at least part of the air flow generated by the fan wheel can pass.

The invention relates to a device comprising a housing having one side on which at least two support feet with support surfaces are provided. The support feet project beyond the surface forming the side, thereby creating a free space between the surface forming the side and the plane in which the support surface coming closest to the surface is located.

Housings of this type are frequently used in clutches and transmissions. For example, gear transmissions are known in practice from the company A. Friedr. Flender AG of Bocholt. These transmissions have a transmission housing that has four support feet having rectangular support surfaces on the bottom of the housing. The support feet project beyond the surface forming the bottom side, with the result that a free space is created between the surface forming the top and bottom side and the plane in which the support surfaces are located.

It has been found with these types of transmissions that their performance capacity, that is, the maximum torque transmittable by the transmission, is limited less by the mechanical stability under load of the components, for example, gears and shafts, than by the so-called thermal performance, that is, the ability to dissipate the heat generated by friction in the housing to the environment.

With this background in mind, the problem to be solved by the invention is to create a device comprising a housing that at least does not have one disadvantage of the prior art, and, in particular, has better ways to dissipate heat generated in the housing to the environment of the housing.

The invention is based on the fundamental concept of utilizing the already existing free space between the plane in which the support surfaces are located and the surface forming the side for the purpose of passing at least a partial flow of air generated by a fan wheel over the surface forming the side.

To this end, the invention provides that device has a drivable shaft that extends through an opening in the housing from outside into the housing. This type of shaft can be utilized to dispose a fan wheel on that section of the shaft located outside the housing, which fan wheel generates a flow of air when the shaft rotates that passes over the surface forming the side. The drivable shaft can be a continuous single-piece shaft that extends outward from inside the housing. The shaft can also be composed of multiple components, for example, a slip-on shaft that is mounted on a drivable adapter, as long as, for example, the adapter terminates in a planar manner with the housing.

According to the invention, provision is made here whereby a cover is attached to the support feet so as to create a free space that is delimited by the cover and the surface forming the side, and through which space at least part of the air flow generated by the fan wheel can pass. The cover here provides the capability of passing the flow of air over the surface in a directed manner. In particular—assuming this is what is desired for a specific constructive design—the cover can be used to ensure that the air flow passes over the entire surface forming the side and exits the housing only when the entire surface of the side has been cooled.

In one preferred embodiment, the cover has elements to affect the air flow which protrude into the free space delimited by the cover and the surface forming the side. These elements for affecting the air flow can, for example, be metal plates. In one preferred embodiment, these metal plates can extend from the cover up to the surface forming the side. In one preferred embodiment, the metal plates are disposed at an angle to the main flow direction of the air flow. Similarly, elements of a different type to affect the air flow may be provided. For example, knob-like bumps can be provided on the cover around which the air flow is made to swirl.

In one preferred embodiment, the surface forming the side has elements to affect the air flow which protrude into the free space delimited by the cover and the surface forming the side. These elements for affecting the air flow can, for example, be metal plates. In one preferred embodiment, these metal plates can extend from the surface up to the cover. In one preferred embodiment, the metal plates are disposed at an angle to the main flow direction of the air flow. Similarly, elements of a different type to affect the air flow may be provided. For example, knob-like bumps can be provided on the surface around which the air flow is made to swirl.

In one preferred embodiment, both the cover and also the surface forming the side have elements to affect the air flow which protrude into the free space delimited by the cover and the surface forming the side.

In one preferred embodiment, the cover is designed to be essentially flat. This allows the cover to be easily fabricated, for example, out of one metal plate. Any elements provided to affect the air flow can be attached to this metal plate, for example, by welding or gluing.

In one preferred embodiment, the cover extends parallel to the plane of the support surfaces. This simplifies attachment of the cover to the housing, in particular, because the housing design structure can be kept symmetrical. Alternatively, it is conceivable to have a cover of preferably flat design extend in antiparallel fashion to the plane of the support surface. For example, for a housing in which the surface forming the side extends parallel to the plane of the support surfaces, a cover can be attached in such a way that the free space delimited by the cover and the surface forming the side tapers down or expands in a wedge-like fashion from the inlet side on which the air flow generated in front of the fan wheel passes into the free space. This approach enables a modification of the flow velocity of the air flow to be achieved.

In one preferred embodiment, the cover has a folded edge on at least one side. The folded edge can extend over the entire side of the cover. In particular, the cover with the folded edge preferably protrudes over the side and is oriented such that a portion of the air flow is deflected by the folded edge after flowing over the side such that this flow passes over another side of the housing adjoining the first side. This enables the housing to be cooled on multiple sides. In one preferred embodiment, the folded edge is provided on that side which is disposed opposite the side of the cover at which the air flow enters the free space. Alternatively, the cover can have folded edges on all sides, or on all sides except for the side on which the air flow enters the free space. This constructive design enables the air flow to be passed the longest distance possible along sides of the housing.

In one preferred embodiment, the support feet each have a projection below the plane of the support surfaces. In this preferred constructive design, the cover rests on the projections of the support surface. It has been found that this constructive design provides an especially effective way of attaching the cover to the housing, in particular in regard to the alignment of the cover relative to the housing. In addition, by this approach it is possible to prevent the cover from protruding beyond the plane of the support surfaces. What is achieved thereby is that the outer dimensions of the device remain unchanged.

In one preferred embodiment, the cover is glued on and/or screwed onto the housing—for example, by means of sheet-metal screws or countersunk screws.

In one preferred embodiment, the cover extends over the entire surface forming the side. What is achieved thereby is that the air flow is passed by the cover over the entire surface of the side. In an alternative embodiment, it is possible for the cover to extend only over part of the surface forming the side. It has been found that an air flow that is passed over parts of the surface still continues to pass effectively over the remaining part of the surface even when it is passed only over a first section of the surface. It is suspected that due to the partial channeling by the cover a direction of flow is imposed on the air flow, this direction being essentially maintained even if the flow is no longer channeled by the cover. In one preferred embodiment, the cover extends over at least 25%, in particular preferably over 50%, and especially preferably over 75% of the surface forming the side.

In one preferred embodiment, the housing is of an essentially rectangular design and has a top side, bottom side, and four lateral surfaces.

In one preferred embodiment, the surface of the side on which the cover is provided extends essentially in one plane.

In one preferred embodiment, the housing has corners at which the surfaces of at least three sides abut one another. In the especially preferred rectangular design of the housing, the housing has eight corners, where at each corner two lateral surfaces and the top side, or the bottom side, abut each other. In one preferred embodiment, support feet are provided at at least three corners of the housing, or two elongated support feet are provided, each of which joins two corners and extends over the width of the housing.

What is preferred in particular is to provide support feet at all corners of the housing. When one support foot is provided at one corner, this support foot is preferably projects beyond all of the surfaces adjoining this corner. Alternatively, the support foot can be designed to be level relative to one of the surfaces abutting the corners and to protrude only relative to one surface or the other surfaces.

In one preferred embodiment, the support feet are designed to aim in the same direction so that their support surfaces lie in the same plane.

The advantages of the invention are achieved, however, simply by having a free space exist between the surface forming the side and the plane lies in which the support surface coming closest to the surface. For example, in order to facilitate the installation situation in which the device is to be installed, it is possible for the support feet to have support surfaces that are located in different surfaces—in particular, in different mutually parallel surfaces. A cover here could, for example, be disposed just below the plane in which the support surface closest to the surface is located, and be laterally attached to the remaining support feet protruding beyond this support foot

In one preferred embodiment, at least one support foot is not disposed at one corner of the housing. For example, one support foot can be disposed on the surface forming the side, for example, in the centroid of this surface. Similarly, one support foot can be disposed on one edge of the housing at which the surfaces of two sides of the housing abut each other.

In one preferred embodiment, the housing is of a rectangular design wherein it has one rectangular side and six support feet, wherein four support feet are disposed at the four corners of the rectangular side and two support feet are disposed at the center of the two edges that form the longitudinal edges of the rectangular side.

In one preferred embodiment, the support feet are of a single-piece design with the housing. Alternatively, all or some of the support feet can be separate components that are attached to the housing, for example, are screwed/bolted to the housing.

In one preferred embodiment, the housing is in the form of a cast housing. This enables the housing to be easily fabricated. In addition, with cast housings it is possible to use materials that have good thermal conductivity, with the result that heat generated in the housing can be conducted effectively through the housing wall.

In one preferred embodiment, the support feet have an essentially constant cross section in the direction of the surface normal of the surface forming the side. Alternatively, it is in fact possible to design the support feet to taper down in the direction of the surface normal of the surface forming the side so that they have a smaller support surface, or, on the other hand, to design them to widen out in the direction of the surface normal of the surface forming the side so that they have an especially large support surface. What is preferred, however, is to design the support feet so as to have an essentially constant cross section. In one preferred embodiment, the sum of the cross sections of the support feet lying in a plane perpendicular to the surface normal has a surface area of approximately 15% of the area forming the side. In one preferred embodiment, the sum of the cross sections lying in a plane perpendicular to the surface normal has a maximum area of approximately 25% and a minimum area of approximately 5% of the area forming the side.

In one preferred embodiment, the maximum distance between the plane in which the support feet lie and the surface forming the side is less than 20 mm, in particular preferably less than 15 mm. In one preferred embodiment, the surface forming the side is of a flat design, wherein the cover and surface have a constant distant relative to each other that is less than 20 mm, in particular preferably less than 15 mm. It has been found that this distance between the surface and the cover enables an effective channeling of the air flow to be achieved.

In one preferred embodiment of the device according to the invention, at least one gear of a transmission is disposed on the section of the shaft that is located in the housing. In addition, another shaft is provided that extends through another opening in the housing from outside into the housing. At least one additional gear of the transmission is disposed on one section of this additional shaft that is located in the housing. The device according to the invention is in particular preferably a transmission. However, the device according to the invention can similarly also be designed as a clutch.

In one preferred embodiment, a transmission is disposed in the housing which is a spur gear transmission or bevel-helical transmission. It has been found that the thermal performance that is enhanced by the generation and channeling of an air flow can be employed especially effectively in transmissions. The air flow generated here by a fan wheel of compact constructive design can significantly enhance the thermal performance of the transmission.

In one preferred embodiment, the device has an additional housing that at least partially surrounds the fan wheel. This is designed in particular to direct the air flow generated by the fan wheel towards the surface forming the side. Here the shape of the housing is preferably selected so that the flow onto the surface and any possibly required deflection of the air flow are effected with low loss. What is preferred in particular is to design the housing surrounding the fan wheel so as to surround the fan wheel in such a way that there is no risk of injury when the fan wheel is operating.

The following discussion describes the invention in more detail based on a drawing illustrating only one exemplary embodiment of the invention. Here:

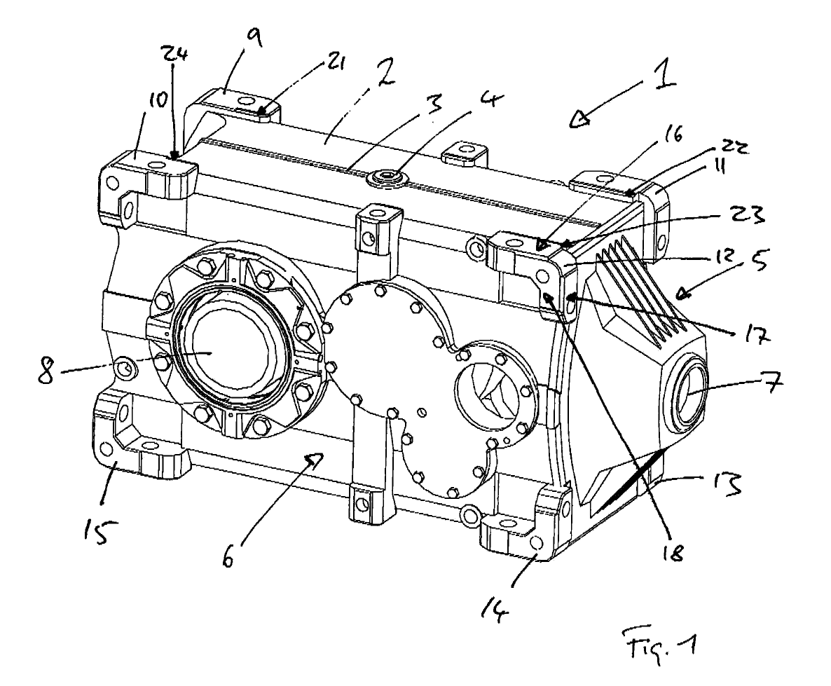

FIG. 1 is a perspective view illustrating a housing of a device according to the invention in which the housing is shown without the cover attached to the support feet; and

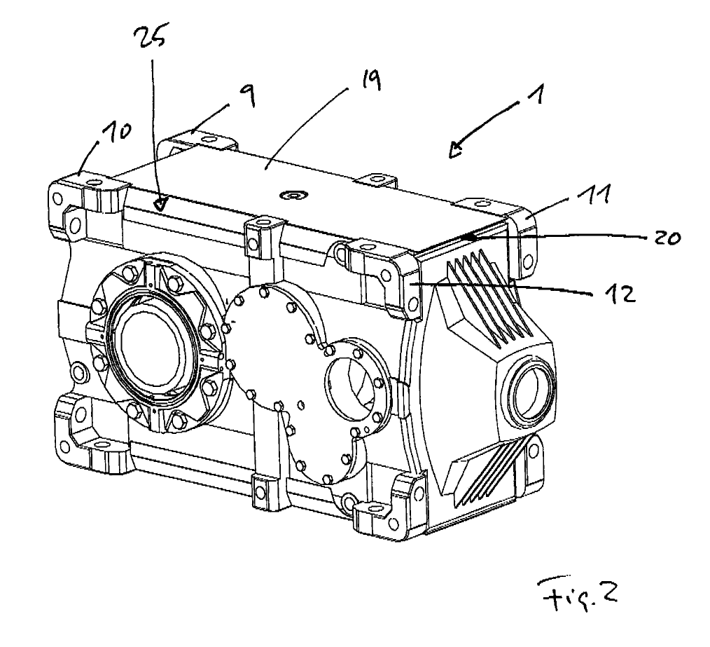

FIG. 2 is perspective view illustrating the housing of FIG. 1 in which the housing is shown with the cover attached to the support feet.

FIG. 1 illustrates a housing 1 of a device designed as a bevel-helical transmission. The base body of housing 1 is essentially of rectangular shape. The surface 2 forming the top side of housing 1 runs in planar fashion, wherein a ridge 3 is provided at the center of surface 2 for fabrication reasons, and what is known as an inspection opening 4 is provided. Surface 2 is of rectangular design.

Housing 1 furthermore has a bottom side (not shown) and 4 sides, the surfaces 5, 6 of two sides being shown in FIG. 1. These surfaces 5, 6 do not run in one plane for design reasons. An opening 7 is provided in surface 5, through which opening a drivable shaft (not shown) extends from outside into housing 1. In surface 6 an opening 8 is provided through which another shaft (not shown) extends from outside into housing 1. Additional openings closed by covers are provided in surface 6. These function to facilitate assembly of the transmission.

Rectangular housing 1 has 8 corners 9, 10, 11, 12, 13, 14, 15 at which two sides each and the top side or bottom side abut each other. In the embodiment shown, housing 1 has support feet at each corner. The support feet are designed such that they each have three support surfaces 16, 17, 18. The identically-oriented support surfaces of the support feet each lie within one plane.

The support feet associated with the top side project beyond surface 2. At the same time, these support feet are designed such that they project beyond that section of the lateral surfaces which immediately borders them. Since the support feet associated with the top side project beyond surface 2, a free space is created between surface 2 and the plane in which support surfaces 16 lie.

When a flow of air is generated by a fan wheel (not shown) disposed on that section of the shaft (not shown) that is located outside housing 1, this flow passes through between the support feet disposed on corners 11, 12 across the surface 2.

As is illustrated in FIG. 2, a cover 19 is attached on the support feet provided at corners 9, 10, 11, 12 so as to create a free space that is delimited by cover 19 and surface 2. The air flow generated by the fan wheel (not shown) passes into this free space through a gap 20 defined between the support feet disposed at corners 11, 12 and surface 2 and cover 19. Cover 19 is designed such that it extends over the entire surface 2.

Projections 21, 22, 23, 24 are seen in FIG. 1, the projections being formed below the plane of the support surfaces. The cover rests on these projections.

On three sides, cover 19 has folded edges 25, each of which extends over the entire side of the cover. Folded edge 25 protrudes beyond surface 2 and is oriented such that a part of the air flow after passing over surface 2 is deflected by folded edge 25 so as to pass over side 6 of housing 1. The cover has folded edges on all sides except for the side at which gap 20 is formed.

1. A device comprising a housing
having one side on which at least two support feet with support surfaces are provided,
wherein the support feet project beyond the surface forming the side,
thereby creating a free space between the surface forming the side and the plane in which the support surface coming closest to the surface is located, wherein
the device has a drivable shaft that extends through an opening in the housing from outside into the housing,
a fan wheel is disposed on that section of the shaft which is located outside the housing, which fan wheel generates a flow of air when the shaft rotates that passes over the surface forming the side, and
a cover is attached to the support feet, thereby creating a free space that is delimited by the cover and the surface forming the side, through which free space at least part of the air flow generated by the fan wheel can pass.

2. The device according to claim 1, wherein the housing is of rectangular shape.

3. The device according to claim 1, wherein the housing has corners at which the surfaces of at least three sides abut one another, and at least one support foot is disposed at a corner.

4. The device according to claim 1, wherein the housing is a cast housing.

5. The device according to claim 1, wherein the support feet have an essentially constant cross section in the direction of the surface normals of the surface forming the side.

6. The device according to claim 1, wherein the surface forming the side is flat, and the distance between the plane in which the support surfaces lie and the surface forming the side is less than 20 mm.

7. The device according to claim 1, wherein at least one gear of a transmission is disposed on that section of the shaft which is located in the housing, and that another shaft is provided which extends through another opening in the housing from outside into the housing and which has a section that is located in the housing, on which section at least one additional gear of the transmission is disposed.

8. The device according to claim 7, wherein the transmission is at least one of a spur gear transmission and a bevel-helical transmission.

9. The device according to claim 1, wherein a housing at least partially surrounds the fan wheel, which housing directs the air flow generated by the fan wheel towards the surface forming the side.

10. The device according to claim 1, wherein the cover is of an essentially flat design.

11. The device according to claim 1, wherein the cover has elements to affect the air flow which project into the free space delimited by the cover and the surface forming the side.

12. The device according to claim 1, wherein the surface forming the side has elements to affect the air flow which project into the free space delimited by the cover and the surface forming the side.

13. The device according to claim 1, wherein the cover has a folded edge on at least one side.

14. The device according to claim 1, wherein the support feet each have one projection below the plane of the support surfaces and that the cover rests on the projections of the support feet.
